(19) United States
(12) Patent Application Publication
(10) Pub. No.: US 2024/0190501 A1
(43) Pub. Date: Jun. 13, 2024

(54) STEER-BY-WIRE STEERING SYSTEM AND METHOD

(71) Applicant: ZF Automotive Germany GmbH, Alfdorf (DE)

(72) Inventors: Peter Hambloch, Krefeld (DE); Martin Gebing, Vreden (DE)

(21) Appl. No.: 18/521,558

(22) Filed: Nov. 28, 2023

(30) Foreign Application Priority Data
Dec. 8, 2022 (DE) 102022213299.8

(51) Int. Cl. B62D 6/00

(52) U.S. Cl. CPC B62D 6/002

(57) ABSTRACT

A steer-by-wire steering system for a vehicle, with a driver-operable control element for steering angle input, an actuating mechanism for setting a wheel setting angle, and a control unit which is configured, on a basis of a steering angle of the control element and a vehicle speed, to output a map for the setpoint of a position of the actuating mechanism. A wheel setting angle is able to be set by the actuating mechanism depending on a set steering angle and on a vehicle speed. A maximum settable wheel setting angle and/or a maximum settable steering angle is limited depending on the vehicle speed. A method is also described for producing a map for the setpoint of a position of the actuating mechanism, for example of the wheel setting angle, in a steer-by-wire steering system.

### CROSS-REFERENCE TO RELATED APPLICATION

This application claims priority to German Priority Application No. 102022213299.8, filed Dec. 8, 2022, the disclosure of which is incorporated herein by reference in its entirety.

### TECHNICAL FIELD

The disclosure concerns a steer-by-wire steering system for a vehicle and a method for producing a map for the setpoint of a position of the actuating mechanism for setting a wheel setting angle in a steer-by-wire steering system.

### BACKGROUND

Steering systems usually comprise a toothed rack which is mounted linearly displaceably for adjusting a wheel setting. Originally, such a toothed rack is coupled to the steering wheel via a steering linkage, so that a linear movement of the toothed rack is achieved via a rotation of the steering wheel.

In modern motor vehicles, so-called steer-by-wire steering systems (SBW) are increasingly used in which there is no longer a mechanical connection between the steering wheel and the toothed rack. The movement of the toothed rack is achieved by an electric drive.

Theoretically, in steer-by-wire steering systems, any translation ratio of a steering angle to a wheel setting angle can be set. However, the physical travel path of the toothed rack or the travel path of the electric drive on the front axle is limited.

Accordingly, a maximum steering angle results from the maximum travel path of the actuating motor on the front axle in combination with the translation ratio of the steering angle to the wheel setting angle. In known solutions, the translation ratio is taken from two-dimensional look-up tables or conversion tables using the steering angle or vehicle speed. The resulting maximum steering angle is not therefore directly included in the design of the steering system.

However, there are applications in which a maximum steering angle is desired which may not be exceeded.

### SUMMARY

What is needed is an improved steer-by-wire steering system and a method for setting a translation ratio in a steer-by-wire steering system.

Accordingly, a steer-by-wire steering system for a vehicle is disclosed, with a driver-operable control element for steering angle input, an actuating mechanism for setting a wheel setting angle, and with a control unit which is configured, on the basis of a steering angle of the control element and a vehicle speed, to output a map for the setpoint of a position of the actuating mechanism, wherein a wheel setting angle able to be set by the actuating mechanism depends on a set steering angle and on a vehicle speed, and wherein a maximum settable wheel setting angle and/or a maximum settable steering angle is limited depending on the vehicle speed.

Setting the wheel setting angle by the actuating mechanism comprises setting one component or multiple components in the steering system, which leads to the wheel setting angle being set. The disclosure thus encompasses any implementation in which the actuating mechanism changes a position or absolute position or orientation of the single component or of the multiple components of the steering system in a manner that results in the wheel setting angle being set. The component or the multiple components may be part of a steering rod of the steering system.

From the map, a ratio can be established between a deflection of the control element and a wheel setting angle set by the actuating mechanism for various travel situations.

The ratio established by the map is a virtual ratio since there is no mechanical connection between the control element and the wheels. The virtual ratio thus replaces the mechanical translation ratio which is no longer present in the steer-by-wire steering system, and is therefore also described as a virtual translation ratio.

Between a steering angle of zero and the maximum steering angle, the virtual translation ratio varies depending on the travel situation.

The wheel setting angle and/or the steering angle is limited, depending on the vehicle speed, to a value that is less than or equal to an absolute, maximum possible wheel setting angle and/or an absolute, maximum possible steering angle.

In one exemplary arrangement, the translation and/or the relationship between wheel setting angle and steering angle is changed as the vehicle speed increases, which leads to safer and better-controllable operation of the vehicle. This makes it possible for example to avoid oversteer of the vehicle as vehicle speed increases.

The absolute maximum possible wheel setting angle may, but need not, correspond to the physically possible maximum wheel setting angle. In one exemplary arrangement, the maximum possible wheel setting angle is a defined wheel setting angle that is able to be set for all vehicle speeds. The maximum possible wheel setting angle is in a defined wheel setting angle that is smaller at higher vehicle speeds than at lower vehicle speeds.

The steering system according to the disclosure has the advantage that a high steering comfort and good drivability of the vehicle are achieved in all travel speed ranges. For example, the high steering comfort is achieved by the variability of the maximum possible steering angle and/or the good drivability is achieved by the variability of the maximum possible wheel setting angle.

Also, the steering system according to the disclosure allows an intuitive and time-efficient application of characteristic curves, which are structured as evenly as possible, for the setpoint of the position of the actuating mechanism and hence also a position of a front axle and a wheel setting angle or trajectory of the vehicle.

The control element is for example a conventional steering wheel, a control column, a flat, flattened or polygonal steering wheel, a rotatable potentiometer or a joystick.

A maximum possible steering angle is usually +/−180°. Thus the steering system is particularly suitable for so-called flat control elements, such as a control column or flat polygonal steering wheels in which multiple full rotations of the steering wheel are not provided but during travel the driver's hands remain in a recommended position, for example, the so-called “quarter-to-three” position on the control element.

The development of a ratio between a deflection of the control element and the wheel setting angle set by the actuating mechanism is determined at least in regions by a polynomial function of the third degree, wherein the speed-dependent, maximum settable steering angle and the speed-dependent, maximum settable wheel setting angle are included in the polynomial function as influencing parameters. The development of the virtual translation ratio is thereby even. Instead of the speed-dependent maximum wheel setting angle, a position of the actuating mechanism at which the speed-dependent maximum wheel setting angle is present may also serve as an influencing parameter.

According to an exemplary arrangement, for a steering angle from zero to a defined speed-dependent steering angle, which is less than the maximum settable speed-dependent steering angle, the ratio between a deflection of the control element and the wheel setting angle set by the actuating mechanism is constant, and the ratio is determined variably by the polynomial function only when the defined speed-dependent steering angle has been exceeded. The constant ratio, for example the virtual translation ratio, is reflected by a linear portion of the characteristic curve. In the region in which the virtual ratio is variable, the curve at least mainly has a non-linear course. The defined speed-dependent steering angle lies for example between 2.5° and 10° depending on speed. This achieves the advantage that at relatively low speeds, the virtual translation ratio is particularly direct around the central position of the steering element. In other words, in this steering angle range, a steering movement is amplified more at slow travel than at high travel speeds. Thus maneuvering the vehicle is comfortable.

For example, within the linear region, the ratio between a deflection of the control element and the wheel setting angle set by the actuating mechanism is determined by a speed-dependent amplification factor. The amplification factor amounts for example to between 0.8 and 2.5. In one exemplary arrangement, the amplification factor is between 0.95 and 2.3. The amplification factor relates either to an established virtual value or to a physical translation ratio, for example to a toothed rack movement per revolution of a pinion acting on the toothed rack. In other words, the amplification factor relates to a reference translation ratio within the steering system or to the overall translation ratio of steering wheel angle to wheel setting angle. Due to a speed-dependent amplification factor, the translation ratio can be defined easily in a linear region.

Alternatively, instead of the amplification factor, an absolute amount of the translation ratio may be applied.

The polynomial function may have a turning point in the steering range. This contributes to an even development of the virtual translation ratio in the polynomial region. In concrete terms, this avoids the virtual translation ratio only increasing slowly in a wide region of the steering angle range and rising rapidly only close to the maximum steering angle. Alternatively, the polynomial function may have a turning point outside of the steering range.

The steering range is the region between zero and the maximum steering angle.

The speed-dependent steering angle, up to which the ratio between a deflection of the control element and the wheel setting angle set by the actuating mechanism is constant, and/or the speed-dependent amplification factor and/or the position of the turning point and/or the maximum settable wheel setting angle and/or the maximum settable steering angle, may be stored in a look-up table for different vehicle speeds. This allows a rapid calculation of the translation ratio in the control unit.

According to one exemplary arrangement, at least two, and in one exemplary arrangement, at least five, for example six travel speed support points are stored in the control unit, wherein the control unit is configured to calculate, for the travel speed support points, a curve of the ratio between the deflection of the control element and the wheel setting angle set by the actuating mechanism via the steering angle. As the travel speed support points for which the curve of the translation ratio is calculated are stored, the translation ratio is calculated precisely only for a limited number of vehicle speeds. Thus the required calculation capacity of the control unit can be significantly reduced.

In one exemplary arrangement, the control unit is configured to interpolate a setpoint for the actuating mechanism between the travel speed support points. In this way, a map for the respective vehicle speed can be established sufficiently precisely even with reduced calculation capacity.

The actuating mechanism may comprise a toothed rack or at least one electromotorized actuator. Both a toothed rack and an electromotorized actuator are suitable for setting a defined wheel setting angle.

For example, a separate electromotorized actuator may be provided for each wheel of a vehicle.

A method for producing a map for the setpoint of a position of the actuating mechanism for setting a wheel setting angle, for example for the setpoint of a wheel setting angle, in a steer-by-wire steering system for a vehicle, wherein the map is produced by a control unit on the basis of a steering angle of a control element and a vehicle speed, such that a wheel setting angle able to be set by the actuating mechanism depends on a set steering angle and on a vehicle speed, and wherein a maximum settable wheel setting angle and/or a maximum settable steering angle is limited depending on the vehicle speed.

As already explained in connection with the steering system, the method according to the disclosure achieves the advantage that an adaptable region within the entire possible wheel setting range is used in a defined steering angle range. Thus a high steering comfort and good drivability of the vehicle are achieved in all travel speed ranges.

The method may also be refined as previously described for the steering system or as indicated in the dependent claims for the steering system.

It is also conceivable that instead of the wheel setting angle, a trajectory of the vehicle may itself be used as a setpoint. The trajectory may be established by use of models for driving simulation.

### BRIEF DESCRIPTION OF DRAWINGS

Further advantages and features of the disclosure arise from the following description and the drawings, to which reference is made. In the drawings:

FIG. 1 shows schematically a steer-by-wire steering system according to the disclosure,

FIG. 2 shows the development of a toothed rack movement for different vehicle speeds, and

FIG. 3 shows the development of a toothed rack movement for different vehicle speeds according to a further exemplary arrangement.

### DETAILED DESCRIPTION

FIG. 1 illustrates schematically a steer-by-wire steering system 10 for a vehicle with a control element 12, which in this exemplary arrangement is a steering wheel.

The steering system 10 furthermore comprises an actuating mechanism 14.

In the exemplary arrangement illustrated, the actuating mechanism 14 comprises a toothed rack 16 and an actuating motor 18, wherein a mechanical translation mechanism—in this exemplary arrangement, implemented as a pinion 19—acts between the toothed rack 16 and the actuating motor 18. Alternatively, a recirculating ball screw or similar is also possible.

The toothed rack 16 forms a front axle which carries two front wheels 20, 22. The system may however also be used on a rear axle.

In an alternative exemplary arrangement which is not illustrated for the sake of simplicity, the actuating mechanism 14 comprises electromotorized actuators instead of a toothed rack 16 and a pinion 19, wherein an actuator is assigned to each wheel 20, 22.

In a steer-by-wire steering system 10, there is no mechanical coupling between the steering wheel 12 and the wheels 20, 22. Instead, a wheel setting angle is set by means of the actuating motor 18.

To this end, the pinion 19, which is in toothed engagement with the toothed rack 19, is rotated by the actuating motor 18, whereby the toothed rack 16 is moved linearly.

Starting from a neutral position, for example a maximum travel of +/−90 mm is set for the toothed rack 16.

The steering system 10 has a sensor 26, e.g. an angle sensor, which serves to detect a steering angle.

On the basis of the steering angle detected by the sensor 26, a signal is sent to an actuating motor 18.

More precisely, the steering system 10 has a control unit 28 which processes a value detected by the sensor 26 and sends a corresponding signal to the actuating motor 18.

The control unit 28 is configured, on the basis of a steering angle of the control element 12 and a vehicle speed, to output a map for the setpoint of a position of the actuating mechanism 14. In concrete terms, a nominal position or state of the actuating motor 18 is predefined. The wheel setting angle is able to be set by the actuating mechanism 14 thus depends on a set steering angle and on a vehicle speed.

In this case, a maximum settable wheel setting angle and/or a maximum settable steering angle is limited depending on the vehicle speed, as explained in even more detail below. The wheel setting angle is furthermore limited to an absolute maximum value. The maximum wheel setting angle is reached when the toothed rack 16 has covered its defined maximum travel.

The maximum travel of the toothed rack 16 is stored in the control unit 28 and can be applied to the steering system 10.

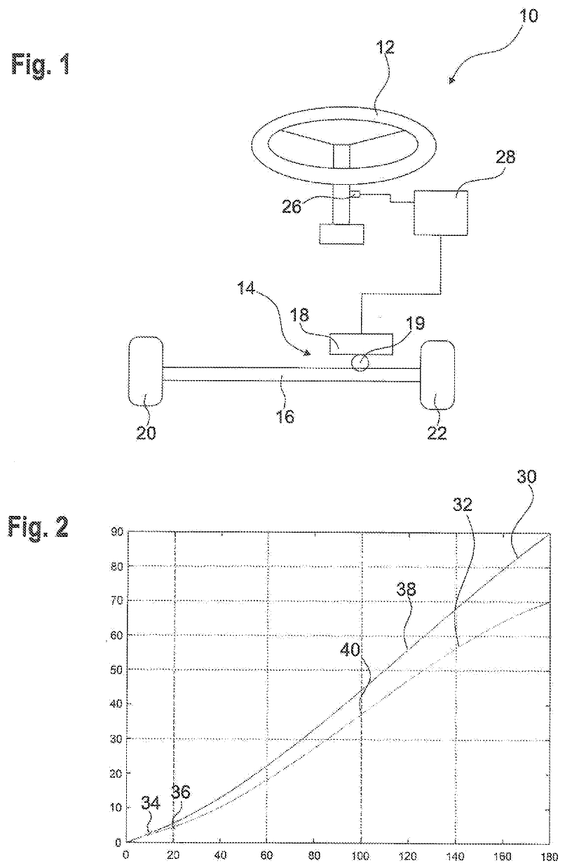

FIG. 2 shows a graph of the toothed rack movement (Y axis) over the steering angle (X axis) for different vehicle speeds.

In FIG. 2, the line 30 illustrates a curve for a speed of 15 km/h and the line 32 illustrates a curve for a speed of 30 km/h.

It is clear from the different courses of the curves 30, 32 that for the different vehicle speeds, for a specific setting of the control element 12, different setpoints apply for a position of the actuating mechanism 14, i.e. different wheel setting angles, or in other words, different target values for the toothed rack travel within the steering angle range.

It is clear from FIG. 2 that the translation ratio is constant for a steering angle from zero up to a defined speed-dependent steering angle. For a vehicle speed of 15 km/h, the defined speed-dependent steering angle is around 10° (identified by point 34), and for a vehicle speed of 30 km/h it is 20° (identified by point 36).

In the linear region, the ratio between a deflection of the control element 12 and the wheel setting angle set by the actuating mechanism 14, i.e. the virtual translation ratio, is determined by a speed-dependent amplification factor. This leads to the different gradients of the curves 30, 32 in the respective linear region.

Alternatively, instead of the amplification factor, a concrete amount which varies according to speed may be selected for the virtual translation ratio.

In the remaining region, the development of the virtual translation ratio is determined by a polynomial function of the third degree. In other words, the virtual translation ratio is determined by the polynomial function when the defined speed-dependent steering angle is exceeded.

In this exemplary arrangement, the polynomial functions each have a turning point 38, 40 in the steering range. For example, curve 30 has a turning point 38 at a steering angle of 120°, and curve 32 has a turning point 40 at a steering angle of 100°.

In concrete terms, the control unit 28 is configured to calculate the development of the ratio between a deflection of the control element 12 and the wheel setting angle set by the actuating mechanism 14, or a toothed rack position y as a function of the steering angle x, outside the linear region according to the following formula:

y(x)=a₃·(x−x₁)³+a₂·(x−x₁)²+a₁·(x−x₁)+a₀
x₁ stands for the defined speed-dependent steering angle up to which the translation ratio is constant;
a₁ stands for the amplification factor in the linear region,
a₀ is the product of the amplification factor in the linear region and the size of the linear region,
a₂ is calculated according to the formula a₂=3·a₃·(x₁−xᵣ), wherein xᵣ describes the position of the turning points,
as is in turn calculated according to the formula:

$${a}_{3} = \frac{{y}_{m} - {a}_{1} \cdot ( {x}_{m} - {x}_{1} ) - {a}_{0}}{{( {x}_{m} - {x}_{1} )}^{3} + 3 \cdot ( {x}_{1} - {x}_{r} ) \cdot {( {x}_{m} - {x}_{1} )}^{2}}$$

xₘ stands for the maximum settable steering angle and yₘ for a maximally deflected position of the toothed rack 16, as a result of which a maximum settable wheel setting angle is also limited.

The maximum settable steering angle and the maximum settable wheel setting angle are accordingly included in the polynomial function as influencing parameters.

In the exemplary arrangement according to FIG. 2, the maximum settable wheel setting angle is speed-dependent. The maximum settable wheel setting angle in particular decreases as speed increases.

In the exemplary arrangement according to FIG. 2, the maximum deflected position of the toothed rack 16 is 90 mm at a speed of 15 km/h and 70 mm at a speed of 30 km/h.

In the exemplary arrangement according to FIG. 2, the maximum steering angle is +/−180°.

In one exemplary arrangement, all influencing parameters are speed-dependent.

For example, several travel speed support points are stored in the control unit 28, in particular 15 km/h, 30 km/h, 50 km/h, 70 km/h, 100 km/h and 150 km/h.

The control unit 28 is configured to calculate precisely the map for the setpoint of a position of the actuating mechanism 14, or in other words a development of the virtual translation ratio or a position of the toothed rack 16, via the steering angle according to the above-mentioned formula.

For the other speeds between the travel speed support points, the control unit 28 may interpolate the setpoint of a position of the actuating mechanism 14.

The speed-dependent steering angle up to which the virtual translation ratio is constant, and/or the speed-dependent amplification factor, and/or an established value for the virtual translation ratio, and/or the position of the turning point and/or the maximum settable wheel setting angle and/or the maximum settable steering angle, may be stored in a look-up table for different speeds, wherein the speeds preferably correspond to the travel speed support points. This simplifies calculation of the translation ratio.

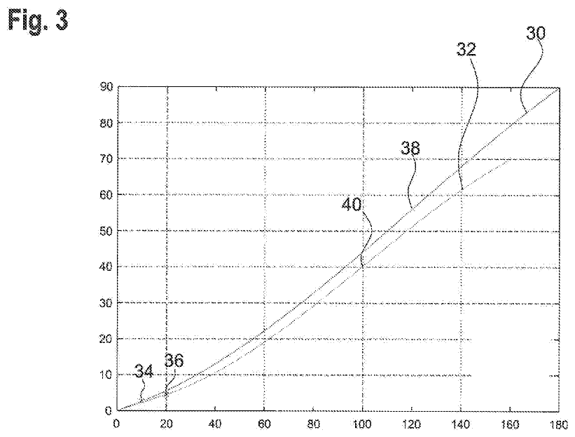

The exemplary arrangement according to FIG. 3 illustrates a further arrangement of the method according to the disclosure.

According to the exemplary arrangement illustrated in FIG. 3, in contrast to the exemplary arrangement illustrated in FIG. 2, the maximum settable steering angle is also speed-dependent, in addition to the maximum settable wheel setting angle.

In the exemplary exemplary arrangement, the maximum settable steering angle is +/−180° at a vehicle speed of 15 km/h and +/−160° at a vehicle speed of 30 km/h.

In a further alternative exemplary arrangement, which is not illustrated for the sake of simplicity, only the maximum settable steering angle is limited.

The described steering system 10 is particularly suitable for performing a method for producing a map for the setpoint of a position of the actuating mechanism 14 for setting a wheel setting angle in a steer-by-wire steering system 10 for a vehicle, wherein the map is produced by the control unit 28 on the basis of a steering angle of a control element 12 and a vehicle speed, such that a wheel setting angle able to be set by the actuating mechanism 14 depends on a set steering angle and on a vehicle speed, and wherein a maximum settable wheel setting angle and/or a maximum settable steering angle is limited depending on the vehicle speed.

1. A steer-by-wire steering system for a vehicle, comprising: a driver-operable control element for steering angle input, an actuating mechanism for setting a wheel setting angle, and a control unit which is configured, based on a steering angle of the control element and a vehicle speed, to output a map for a setpoint of a position of the actuating mechanism, wherein a wheel setting angle, able to be set by the actuating mechanism, depends on a set steering angle and on a vehicle speed, and wherein a maximum settable wheel setting angle and/or a maximum settable steering angle is limited depending on the vehicle speed.

2. The steering system as claimed in claim 1, wherein development of a ratio between a deflection of the control element and the wheel setting angle set by the actuating mechanism is determined at least in regions by a polynomial function of the third degree, wherein a speed-dependent, maximum settable steering angle (xₘ) and a speed-dependent, maximum settable wheel setting angle are included in the polynomial function as influencing parameters.

3. The steering system as claimed in claim 2, wherein for a steering angle from zero to a defined speed-dependent steering angle, the ratio between a deflection of the control element and the wheel setting angle set by the actuating mechanism is constant, and the ratio is determined by the polynomial function only when the defined speed-dependent steering angle has been exceeded.

4. The steering system as claimed in claim 3, wherein within a linear region, the ratio between a deflection of the control element and the wheel setting angle set by the actuating mechanism is determined by a speed-dependent amplification factor.

5. The steering system as claimed in claim 2, wherein the polynomial function has a turning point in the steering range or outside of the steering range.

6. The steering system as claimed in claim 3, wherein the speed-dependent steering angle (x₁), up to which the ratio between a deflection of the control element and the wheel setting angle set by the actuating mechanism is constant, and/or the speed-dependent amplification factor (a₁) and/or the position of the turning point and/or the maximum settable wheel setting angle and/or the maximum settable steering angle are stored in a look-up table for different vehicle speeds.

7. The steering system as claimed claim 1, wherein at least two travel speed support points are stored in the control unit, wherein the control unit is configured to calculate, for the travel speed support points, a curve of the ratio between a deflection of the control element and the wheel setting angle set by the actuating mechanism via the steering angle.

8. The steering system as claimed in claim 7, wherein the control unit is configured to interpolate a curve of the ratio between a deflection of the control element and the wheel setting angle set by the actuating mechanism between the travel speed support points.

9. The steering system as claimed in claim 1, wherein the actuating mechanism comprises a toothed rack or at least one electromotorized actuator.

10. A method for producing a map for a setpoint of a position of an actuating mechanism in a steer-by-wire steering system for a vehicle, comprising adapting a map by a control unit on a basis of a steering angle and a vehicle speed, such that a wheel setting angle that is settable by the actuating mechanism depends on a set steering angle and on a vehicle speed, and limiting a maximum settable wheel setting angle and/or a maximum settable steering angle, depending on the vehicle speed.

11. The steering system as claimed in claim 4, wherein the polynomial function has a turning point (38, 40) in the steering range or outside of the steering range.

12. The steering system as claimed in 11, wherein the speed-dependent steering angle (x₁), up to which the ratio between a deflection of the control element and the wheel setting angle set by the actuating mechanism is constant, and/or the speed-dependent amplification factor (a₁) and/or the position of the turning point and/or the maximum settable wheel setting angle and/or the maximum settable steering angle are stored in a look-up table for different vehicle speeds.

13. The steering system as claimed claim 11, wherein at least two travel speed support points are stored in the control unit, wherein the control unit is configured to calculate, for the travel speed support points, a curve of the ratio between a deflection of the control element and the wheel setting angle set by the actuating mechanism via the steering angle.

14. The steering system as claimed in claim 13, wherein the control unit is configured to interpolate a curve of the ratio between a deflection of the control element and the wheel setting angle set by the actuating mechanism between the travel speed support points.

15. The steering system as claimed in claim 2, wherein five travel speed support points are stored in the control unit, wherein the control unit is configured to calculate, for the travel speed support points, a curve of the ratio between a deflection of the control element and the wheel setting angle set by the actuating mechanism via the steering angle.

16. The steering system as claimed in claim 11, wherein the actuating mechanism comprises a toothed rack or at least one electromotorized actuator.
